(19) United States
(12) Patent Application Publication
(10) Pub. No.: US 2001/0029924 A1
(43) Pub. Date: Oct. 18, 2001

(54) Fuel supply system

(76) Inventor: Harold E. Phelps, Plymouth, MI (US)

Correspondence Address: Irvin L. Groh, Gifford, Krass, Groh, Sprinkle,, Anderson & Citkowski, P.C., 280 N. Old Woodward Avenue, Suite 400, Birmingham, MI, 48009-5394, US

(21) Appl. No.: 09/753,807

(22) Filed: Jan. 3, 2001

Related U.S. Application Data
(60) Provisional application No. 60/174,359, filed on Jan. 4, 2000.

(51) Int. Cl. F02M 37/04

(52) U.S. Cl. 123/382; 123/504

(57) ABSTRACT

A fuel supply or management system in which fuel is delivered in pulses for each power stroke of the engine with the quantity of fuel in each pulse being determined by the speed and load of the engine through a pump control modifying the effect of operation of a reciprocating variable volume, positive displacement fuel pump by controlling the effective stroke of the pump. Fuel is delivered in accordance with the speed of and the load on the engine so that only the amount of fuel required is delivered thereby minimizing the exhaust of unburned fuel and pollution of the environment and eliminating the need for a fuel return line for excess fuel supplied.

This application claims the benefit of U.S. Provisional Application having Serial No. 60/174,359 filed Jan. 4, 2000.

### FIELD OF INVENTION

This invention relates to fuel supply or management systems for small internal combustion engines of both two and four-cycle types.

### BACKGROUND OF INVENTION

The operation of small internal combustion engines which are used with a variety of tools and equipment, such as lawn mowers, chainsaws, leaf blowers and the like require that the carburetor or fuel control system be simple and capable of controlling operation in all possible positions of the engine. At the same time, the engine must be controlled so that it operates effectively and minimizes the exhaust of unburned fuel and oil to the atmosphere.

Present day small engines typically use conventional carburetors to manage fuel delivery to the combustion chamber of the engine. Carburetors operate inefficiently in that unburned fuel is exhausted to the atmosphere resulting in pollution. Such systems, however, have been refined over many years and perform dependably and are of relatively low cost. The injection of fuel is more advantageous because it permits more accurate control of the amount and timing of the delivery of the fuel to the combustion chamber of the engine so that reduced emissions and increased power result. Typically, however, injection of fuel is controlled electronically. This is impractical for small engines because the control module alone could exceed the cost of the small engine.

### SUMMARY OF INVENTION

It is an object of the invention to provide a mechanical fuel control or management system that can be used with two or four-cycle engines in which a predetermined quantity of fuel is injected for each intake stroke of the engine.

Another object of the invention is to provide a fuel supply system having a pump with a variable volume intake and a positive displacement discharge.

Still another object of the invention is to provide a fuel supply system in which the fuel delivered is in direct proportion to the engine speed and load and only the required amount of fuel is supplied to the engine.

It also is an object of the invention to provide a mechanically operated fuel control system which is simple and economical to produce and operates efficiently to deliver only the fuel required to obtain speed and power requirements without excessive emission of fuel and without need for a fuel return line.

The objects of the invention are achieved by a fuel system for an engine in which fuel is delivered to the mixing passage of a four-cycle engine or the combustion chamber of a two-cycle engine by a pump in which the output is controlled by modifying the stroke of the pump in response to vacuum level developed by the engine, which reflects speed and load on the engine.

The pump is reciprocated and the effective stroke of the output piston is controlled by an elongated cam which is moved longitudinally in response to engine speed and load over a range reflecting low to high speeds to accomplish short strokes at low engine speed and longer strokes at high engine speed.

### DESCRIPTION OF THE DRAWINGS

FIG. 1 is a cross-sectional view of a two-cycle engine embodying the fuel supply or management system of the invention;

FIG. 2 is a diagrammatic view of a pump and pump control used in the fuel supply system of the engine of FIG. 1 or with four-cycle engines;

FIG. 3 is a view similar to FIG. 1 showing a four-cycle engine utilizing the fuel supply system of the present invention;

FIG. 4 is a cross sectional view at an enlarged scale of a fuel supply nozzle forming a component of the fuel control system for both types of engines seen in FIGS. 1 and 3; and

FIG. 5 is a diagrammatic view of a variation of the pump and pump control of FIG. 2 for use with the engine of FIG. 1 or 3.

### DETAILED DESCRIPTION OF THE PREFERRED EMBODIMENT

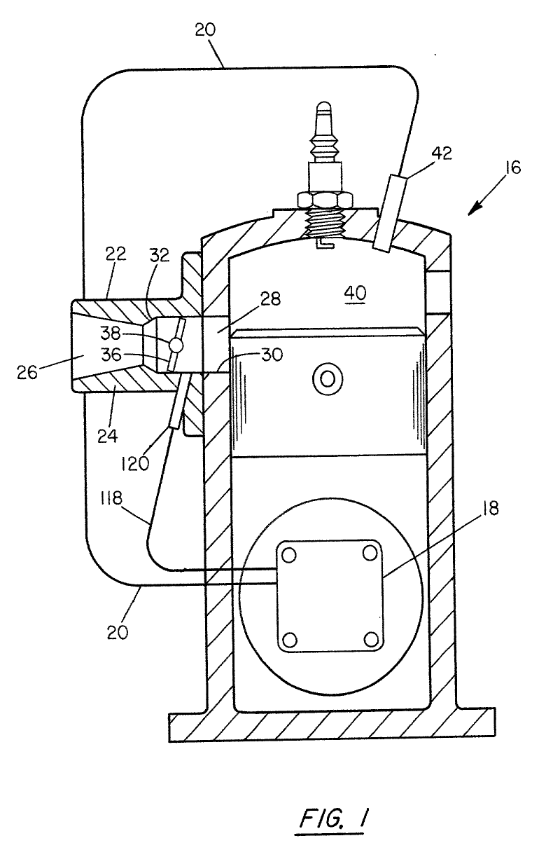

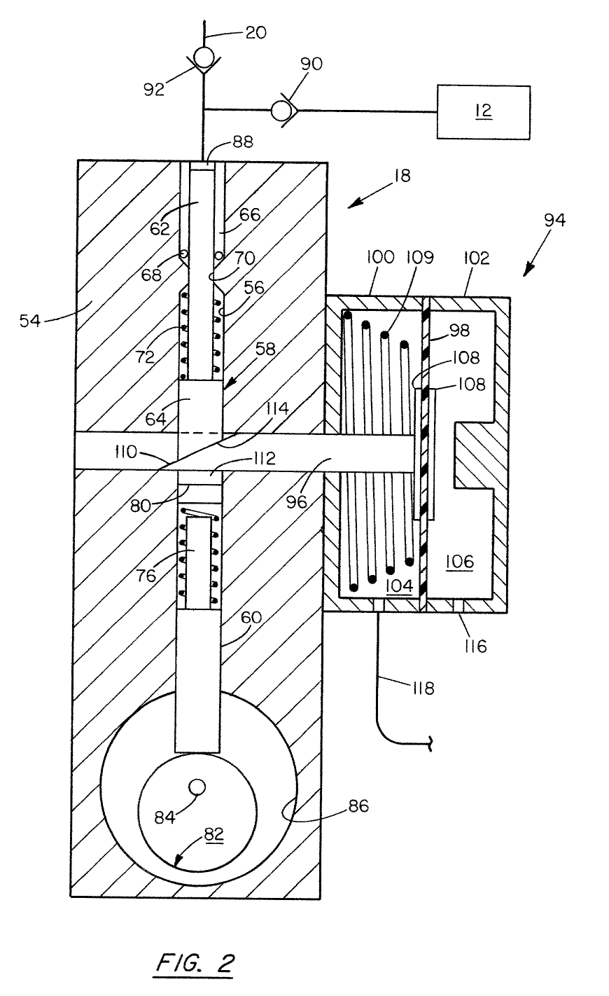

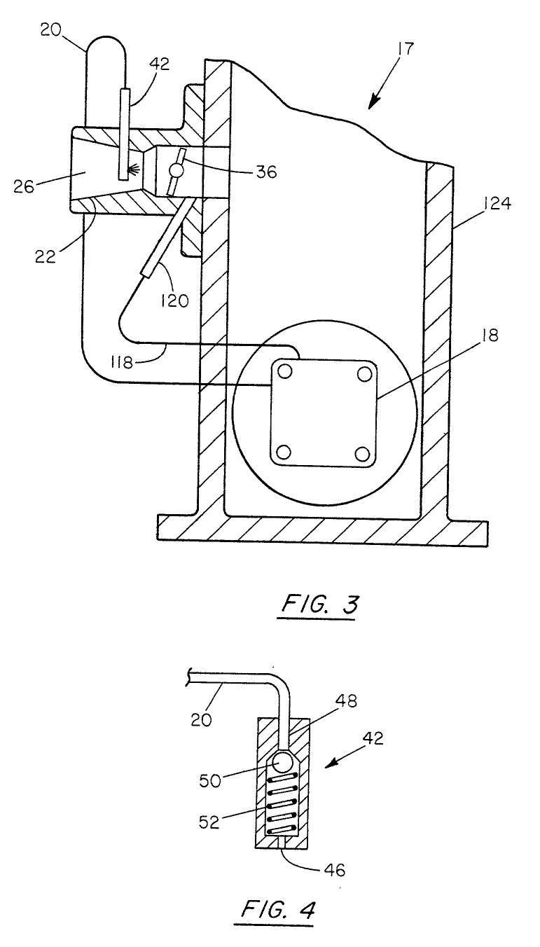

The fuel supply system of the present invention is used to control the delivery of fuel from a tank or reservoir 12 seen in FIG. 2 to the combustion chamber of a two-cycle engine 16 seen in FIG. 1 or to a four-cycle engine 17 as seen in FIG. 3. The fuel is injected at a positive pressure and the amount of fuel is metered in timed relation with the intake stroke of the engine. In both cases, delivery of fuel is from a reciprocating pump 18 or 130 through a line 20 to the engine.

The two-cycle engine depicted in FIG. 1 is provided with a throttle body 22, which includes a housing 24 having an air intake opening 26 at one end in communication with an outlet passage 28. The outlet passage 28 communicates with an air intake port 30 of the engine 16. A Venturi passage or section 32 is formed between openings 26 and 28 to create a low-pressure effect in a mixing chamber 34 downstream of the Venturi section 32. The mixing passage 34 is provided with a conventional butterfly or throttle valve 36 supported on a shaft 38 extending transversely to the axis of the passage. The valve 36 is rotated to regulate the flow of air passing through the throttle body 22 into the combustion chamber 14.

In a two-cycle engine 16, fuel is delivered to the combustion chamber 40 by means of a nozzle 42 receiving fuel through fuel line 20. The nozzle 42 is generally cylindrical and as seen in FIG. 4, has a small discharge opening indicated at 46 through which fuel is discharged into the combustion chamber 16. The end of the nozzle 42 opposite to the discharge opening 46 has a passage 48, which receives fuel from the pump 18 by way of the fuel delivery conduit 20. The fuel passage 48 has a ball check valve 50, which is urged toward its closed position on one end of passage 48 by a spring 52.

The fuel pump 18 seen in FIG. 2 has a housing 54 forming a longitudinally extending bore 56, which extends substantially the full length of the housing 54. A pair of plunger assemblies including an upper plunger 58 and a lower plunger 60 are mounted within the bore 56 for reciprocating movement. The upper plunger 58 includes a stem portion 62, which is of smaller diameter than the head portion 64, and slides in a sleeve 66 fixed in the upper end of bore 56. The end of sleeve 66 also acts to seat a seal 68 between it and a reduced portion 70 of bore 56. The seal 68 acts on the moving exterior of stem 62 to form a seal. The free end of stem 62 acts as a piston head to draw fuel and eject fuel from a chamber 88 formed in sleeve 66 at the upper end of bore 56.

A spring 72 surrounds stem 62 and is seated against the reduced bore portion 70 and piston head 64 to urge the plunger 58 downwardly in the bore 56. The lower plunger 60 has a head 74 and a stem 76 of smaller diameter than the head 74 slidably mounted in bore 56 and urged away from the upper plunger 58 by a compression spring 78 acting between head 74 and the lower end 80 of plunger head 64. The lower plunger 60 forms a drive member, which is reciprocated by a cam 82. The cam 82 is rotated in timed relation to the rotation of the crankshaft of the two-cycle engine. As a result, when plunger 60 moves upwardly the force of spring 78 is overcome and the plunger stem 76 engages the lower end 80 of upper plunger 58 and moves it upwardly against the force of spring 72. This occurs once for every revolution of a two-cycle engine.

The cam 82 is rotated about the axis of shaft 84 in a housing chamber 86 formed at lower end of pump housing 54 and communicating with the lower end of bore 56. Upon rotation of cam 82, the plungers 58 and 60 are reciprocated in the bore 56 so that stem 62 forms a piston that is moved upwardly in the sleeve 66, which forms a cylinder. As the cam 82 is rotated continuously, the plunger members 58 and 60 are reciprocated and fuel is drawn into and expelled from the chamber 88 formed at the upper end of bore 56. During the downward stroke of the plunger 58 under the urging of spring, 72 fuel is drawn from the fuel tank 12 through an open check valve 90 while a check valve 92 in fuel delivery line 20 remains closed. Upon the upward stroke of plunger 58, fuel is forced through open check valve 92 through line 20 to the injection nozzle 42 and at the same time the check valve 90 closes to the fuel supply 12.

The output volume of the pump 18 is variable and is regulated automatically by controlling the length of the stroke of the pump plunger 58 in response to the speed setting and load on the two-cycle engine by a stroke control mechanism designated generally at 94. The stroke control mechanism 94 includes an actuating rod 96 movable in response to movement of a pressure responsive wall formed by a flexible diaphragm 98. The outer periphery of the diaphragm 98 is clamped between the housing member 100 and 102 to form chambers 104 and 106 at opposite sides of the diaphragm 98. The actuating rod 96 is connected to the diaphragm 98 by way of backing plates 108 at opposite sides of the diaphragm. Also, a spring 109 acts to urge the diaphragm toward the right as seen in FIG. 2.

The end of the actuating rod 96 opposite to the diaphragm 98 is formed with an inclined cam surface 110 which passes through an opening 112 formed to extend transversely through the head 64 of the upper plunger 58. The upper wall of transverse opening 112 has an inclined surface 114, which is complementary to the inclined surface 110 on the end of the actuating rod 96.

In FIG. 2 the parts are illustrated in a condition in which the output stroke of pump 18 is intermediate a maximum and a minimum stroke. The maximum stroke of the pump plunger 58 is achieved when the actuating rod 96 is moved to the right from the position seen in FIG. 2 and will be at a minimum when the actuating rod is moved to the left. The length of stroke of pump 18 and consequently its fuel output is determined by the size of the spacing between the end of stem 76 of lower plunger 60 and the bottom end 80 of the upper plunger 58. The spacing is determined by interference between the cam surfaces 110 and 114 associated with the stroke control mechanism 94.

Movement of the actuating rod 96 to control the output stroke of the pump 18 is achieved by varying the level of vacuum pressure in chamber 104. The pressure in vacuum chamber 104 is opposed by atmospheric pressure in chamber 106, which is in continuous communication with the exterior of the housing member 100 through vent 116.

Vacuum chamber 104 is connected by way of a vacuum control line 118 with a source of vacuum in the form of a vacuum intake member 120 seen in FIG. 1. The vacuum intake member 120 is in the form of a tube communicating with the throttle body 22 downstream of throttle valve 36. Vacuum pressure at this point is responsive to engine speed and loading so that variations in vacuum are made apparent through the line 118 in the vacuum chamber 104 of the stroke control mechanism 94. The result in pressure differential of atmospheric pressure in chamber 106 and variable vacuum pressure in chamber 104 acts on the diaphragm 98 to cause movement of the actuating rod 96 and similar movement of cam surface 110 which in turn regulates the effective length of stroke of the plunger 58 to control the volume of pulses of fuel that can pass from the source of fuel 12 to the fuel output line 20 communicating with the fuel delivery nozzle 42.

When the engine is operating, the cam 82 is rotated in direct relation with the rotation of the engine so that the lower plunger 60 of pump 18 is reciprocated continuously with a constant stroke. The end of stem 76 moves into engagement with the lower end 80 of upper plunger 58 causing it to move with its stroke determined by the position of the mating cam surfaces 110 and 114 so that the stroke of the upper plunger 58 can be equal to or something less than the stroke of the lower plunger 60.

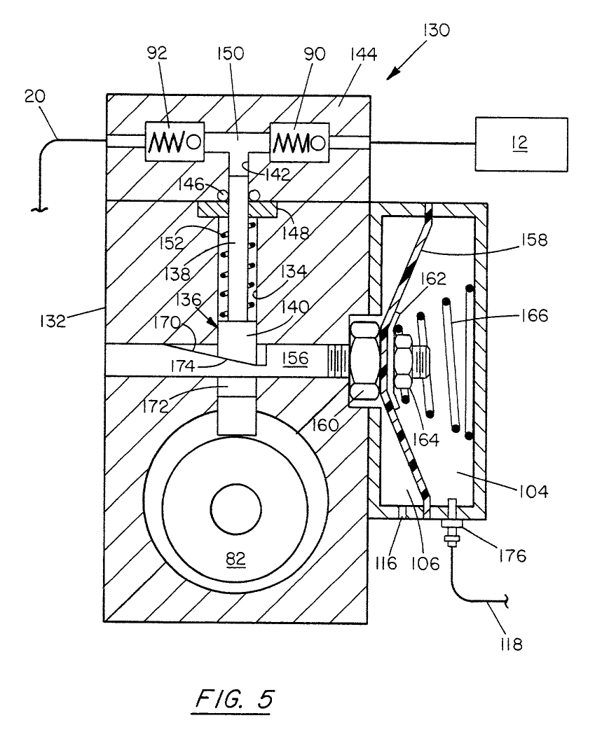

A variation from fuel pump 18 is illustrated in FIG. 5 in the form of fuel pump 130. Fuel pump 130 has a main housing 132 with a longitudinally extending bore 134. The bore 134 receives a single plunger 136 as opposed to the pair of plunger assemblies 58 and 60 in the embodiment of the invention seen in FIG. 2. The plunger 136 includes a stem 138 smaller in diameter than the head portion 140. The upper end of the stem 138 slides in the bore 142 which is an extension of the bore 134 and is formed in an end cap 144 fastened to the housing 132. The end cap 144 also serves to support the valves 90 and 92 and connections to the fuel tank 12 and to the output line 20. Stem 138 also slides in a seal 146 disposed between a spring plate 148 seated in a surface of housing 132 and a cavity in end cap 134. The free end of the stem 138 acts as a piston head which upon reciprocation draws fuel and ejects fuel from the chamber 150 formed in end cap 144 and communicating with valves 90 and 92.

A spring 152 surrounds the stem 138 and has opposite ends seated against the spring seat 148 and the head 140 to urge the plunger 136 downwardly toward the rotating cam 82 which is driven as described in connection with FIG. 2.

As with the embodiment of the pump 18 in FIG. 2, the pump 130 in FIG. 5 is regulated automatically by varying the stroke of the pump plunger 136 in response to the speed setting and load on the two-cycle engine. Modification is accomplished by stroke control mechanisms 154. The stroke control mechanism 154 includes an actuating rod 156 moveable in response to movement of a pressure responsive wall in the form of a flexible diaphragm 158 operating and supported in much the same manner as flexible diaphragm 98 in FIG. 2.

The actuating rod 156 is threaded at one end to receive threaded nut 160 forming a backing plate at one side of the diaphragm 158. A second backing plate is in the form of a washer 162 which is seated against the opposite sides of the diaphragm 158 and held in position by a nut 164. A spring 166 acts to urge the diaphragm to the left as viewed in FIG. 5 so that the nut 160 engages a wall of the housing 132 to determine the initial position of the actuating rod 156.

The end of the actuating rod 156 opposite to the diaphragm 158 is formed with an inclined cam 170 which is positioned in an opening 172 extending transversely through the head 140 of the plunger 136. The upper wall of the opening 172 has an inclined surface 174 which is complementary to the incline surface of the elongated cam 170.

In FIG. 5 the parts are illustrated in the condition in which the output stroke of the piston or stem 138 of pump 130 is at a maximum. The minimum stroke of the pump plunger 136 is achieved when the actuating rod 156 is moved to the right from the position seen in FIG. 5. Such movement will raise the plunger 136 so that the rotating cam 82 is out of engagement for part of each rotation and moves into engagement with the plunger 136 through only part of its full rotation to provide a shortened stroke.

Movement of the actuating rod 156 to control the output stroke of the pump 130 is achieved in the same manner as the embodiment shown in FIG. 2, that is by varying the level of vacuum pressure in chamber 104 which is opposed by atmospheric pressure in chamber 106 in continuous communication with the exterior of the housing member through vent 116.

The vacuum chamber 104 is connected to a source of vacuum by way of a vacuum control line 118 in the same manner as the embodiment in FIG. 2.

The embodiment shown in FIG. 5 makes it possible to adjust the operation of the device for operation at different altitudes or elevations. This is accomplished through the adjustment of the nuts 160 and 162 on the actuating rod 156 to shift the entire range of low to high-speed adjustment to the right for high altitudes and to the left for low altitudes.

In operation, the engine in FIG. 1 is started by rotation of the crankshaft, which also causes rotation of drive cam 82 with resultant reciprocation of plungers 58 and 60 in FIG. 2 or plunger 136 in FIG. 5. This causes fuel to enter the fuel chamber 88 or 142 upon a downward stroke and to be ejected upon an upward stroke of the plungers with fuel passing through check valve 92 to line 20 and to the nozzle 42 in the head of the engine as seen in FIG. 1. At the same time air is introduced through the throttle body 22 for mixing with the fuel injected through the nozzle 42 to cause detonation in combustion chamber 40 and resultant powered operation of the engine.

After engine rotation begins, the throttle valve 36 can be moved to a select position to control air intake and speed of the engine. At high engine speed, the vacuum level will be lower than at lower engine speeds and as a consequence cam 110 will move to the right as seen in FIG. 2 or to the left to the position in FIG. 5. Under this condition, the pump stroke of the upper plunger 58 or 136 will be relatively long so that the predetermined amounts of fuel delivered by pump 18 or 130 to the fuel line 20 will be sufficiently large to accommodate the requirements of high speed operation.

When the engine is operating at high speed and the throttle valve 36 is moved from its open towards its closed position, the vacuum level at the vacuum intake 120 will immediately increase. The resultant reduction in pressure in chamber 104 will cause the actuating rod 96 to move to the left as viewed in FIG. 2 and to the right in FIG. 5 so that the output pump stroke of plunger 58 or plunger 136 will decrease and smaller amounts or pulses of fuel will be metered from pump 18 or 130 to nozzle 42 for low speed operation.

If it can be assumed that fuel requirements between low speed and high speed are essentially a straight-line function, the cam surface 110 can be straight. On the other hand, the contour or shape of the cam surface 110 can be modified to more accurately reflect fuel requirements and control the volume of fuel delivered at various intermediate speeds.

If ignition of the engine is terminated to stop the engine, the check valve 50 in the nozzle 42 in FIG. 4 will immediately close to prevent undesirable fuel flow and the emission of unburned fuel. Also, closing of the check valve 50 maintains fuel in line 20 for instant supply to the nozzle 42 upon restarting the engine.

Operation of the fuel management system of the present invention has been described in connection with a two-cycle engine. Only slight modifications and differences are required for similar operation and the regulation of the fuel supply of a four-cycle engine.

In a two-cycle engine as seen in FIG. 1 fuel from line 20 is delivered to injection nozzle 42 in the head of the engine. With a four-cycle engine, as best seen in FIG. 3, the fuel from pump 18 or 130 is delivered through fuel line 20 to injection nozzle 42 positioned upstream of throttle valve 36 in the throttle body 22. This permits the injection of pulses of fuel without the need to overcome high compression within the combustion chamber of four-cycle engines. This is not a problem with two-cycle engines. In addition the pump 18 or 130 is driven through a cam or reduction gear system (not shown) so that there is an output stroke of the fuel pump for every other revolution of the four-cycle engine as opposed to every revolution in a two-cycle engine.

In the case of the four-cycle engine, the vacuum intake 120 can be located in the same manner as the vacuum intake for the two-cycle engine, that is, downstream of the butterfly valve 36.

With both pumps 18 or 130, a one-way check valve can be located in line 118 as designated at 176. This serves to dampen pulsations of vacuum pressure to maintain a substantially uniform level.

A fuel supply system has been provided in which fuel is delivered in pulses for each power stroke of the engine, the quantity of fuel in each pulse being determined by the speed and load of the engine through a pump control, which modifies the effective operation of a reciprocating fuel pump by controlling the effective stroke of the pump. The fuel is delivered in accordance with the speed of and the load on the engine so that only the amount of fuel required is delivered thereby minimizing the exhaust of unburned fuel and pollution of the environment.

I claim,

1. A fuel supply system for a reciprocating engine, the combination comprising:
a fuel injector for receiving and delivering fuel to an engine cylinder,
a source of fuel,
a variable volume, positive displacement pump having an inlet for receiving fuel from said source and an outlet for delivering fuel to said injector, said pump being driven in timed relation to the reciprocation of said engine,
a source of vacuum pressure proportional to speed and load on said engine, and
control means responsive to the level of vacuum in said source of vacuum to limit the displacement of said pump in proportion to the level of said vacuum in said source of vacuum whereby predetermined amounts of fuel are delivered from said pump to said throttle body for each intake stroke of said engine in proportion to the speed and load on said engine.

2. A fuel supply system in which said pump includes a reciprocation piston means and a rotatable cam engaging said piston means to reciprocate the latter.

3. A fuel supply system according to claim 2 and further comprising a sliding cam moveable to regulate the length of stroke of said piston means.

4. The fuel supply system of claim 3 wherein said sliding cam has a lift portion varying from a maximum to a minimum over the length of said sliding cam and wherein said sliding cam is moveable between predetermined positions.

5. The fuel supply system of claim 4 and further comprising a fluid pressure motor having a vacuum chamber communicating with vacuum in said source to move said sliding cam between said predetermined positions.

6. The fuel supply system of claim 1 wherein the stroke of said pump is at a maximum when said engine is operating at maximum speed and at a minimum stroke when said engine is operating at minimum speed.

7. The fuel supply system of claim 1 and further comprising a nozzle receiving fuel from said pump and having an outlet passage to deliver a predetermined quantity of fuel.

8. The fuel supply system of claim 7 wherein said engine has a combustion chamber and said outlet passage is disposed in said combustion chamber.

9. The fuel supply system of claim 7 wherein said engine has a throttle body for mixing fuel and air and wherein said outlet passage is disposed in said throttle body.

10. The fuel supply system of claim 7 wherein said predetermined amounts of fuel are delivered at a positive pressure for each delivery stroke of said pump.

11. The fuel supply system of claim 10 wherein said nozzle has pressure responsive shut-off valve operative to close said nozzle to the passage of fuel when said engine stops rotating.

12. The fuel supply system of claim 11 wherein a valve is provided at the outlet of said pump to close upon stopping of said engine to retain fuel between said valve and said nozzle in readiness for restarting of said engine.

13. A fuel supply system for a reciprocating engine, the combination comprising:
a source of engine vacuum proportional to engine speed and load,
a fuel reservoir,
a mixing chamber for receiving air and fuel,
a nozzle positioned to deliver fuel to said mixing chamber,
a pump having a reciprocating piston together with an inlet for receiving fuel from said reservoir and an outlet for delivering fuel to said nozzle;
a drive member moveable in timed relationship to the rotation of said engine and being moveable to engage said piston to reciprocate the latter,
a program cam engageable with said piston to define the length of its reciprocating stroke in a range between a minimum stroke and a maximum stroke; and
means responsive to vacuum in said source for moving said program cam to vary the stroke of said piston and displacement of said pump in proportion to engine speed and load.

14. The combination of claim 13 wherein said drive member is a reciprocating member.

15. The combination of claim 14 and further comprising resilient means between said drive member and said piston to urge said drive element and said piston element away from each other.

16. The combination of claim 15 and further comprising an additional resilient means urging said piston towards said drive element with a force greater than that exerted by said first mentioned resilient means.

17. The combination of claim 13 wherein said drive member is a rotating member.

18. The combination of claim 13 wherein the stroke of said pump is at a maximum at a high speed of said engine and said stroke is at a minimum at low speed of said engine.

19. The combination of claim 13 where said program cam is an elongated cam extending transversely to the axis of said reciprocating piston.

20. The combination of claim 19 wherein position of said elongated cam is adjustable longitudinally relative to said means responsive to vacuum to select the displacement of said pump at said minimum and maximum strokes of said piston.
